(19) United States
(12) Patent Application Publication
(10) Pub. No.: US 2018/0026575 A1
(43) Pub. Date: Jan. 25, 2018

(54) SOLAR ROOF MOUNTING SURFACE TRANSITION

(71) Applicant: SUNPOWER CORPORATION, San Jose, CA (US)

(72) Inventors: Benjamin Cadbury Wong, Santa Cruz, CA (US); John Paul Kapla, Mill Valley, CA (US); Kyle Donald Feldmann, Richmond, CA (US); Dylan Benjamin, San Francisco, CA (US)

(21) Appl. No.: 15/282,126

(22) Filed: Sep. 30, 2016

Related U.S. Application Data
(60) Provisional application No. 62/366,500, filed on Jul. 25, 2016.

(51) Int. Cl. H02S 20/23; H02S 40/36

(52) U.S. Cl. CPC H02S 20/23; H02S 40/36

(57) ABSTRACT

A fixture may be installed on a mounting surface such as a roof of a structure. The fixture may be coupled to round elongated components such as wires, cables, conduits, pipes, or tubes that need to be transitioned from the exterior of the structure on top of the mounting surface to the interior of the structure below the mounting surface by passing through the mounting surface. To prevent moisture such as precipitation from penetrating the mounting surface, a mounting surface transition may be used to transition the round elongated components through the mounting surface. The transition may include compression fittings to establish a moisture barrier around the round elongated components.

### CROSS-REFERENCE TO RELATED APPLICATIONS

This application claims priority to U.S. Provisional Patent Application No. 62/366,500, filed Jul. 25, 2016, the entire contents of which are hereby incorporated by reference herein in their entirety and for all purposes.

### BACKGROUND

Solar power has long been viewed as an important alternative energy source. To this end, substantial efforts and investments have been made to develop and improve upon solar energy collection technology. Of particular interest are residential-, industrial- and commercial-type applications in which relatively significant amounts of solar energy can be collected and utilized in supplementing or satisfying power needs. One way of implementing solar energy collection technology is by assembling an array of multiple solar modules.

One type of solar energy system is a solar photovoltaic system. Solar photovoltaic systems (“photovoltaic systems”) can employ solar panels made of silicon or other materials (e.g., III-V cells such as GaAs) to convert sunlight into electricity. Photovoltaic systems typically include a plurality of photovoltaic (PV) modules interconnected with wiring to one or more appropriate electrical components (e.g., switches, inverters, junction boxes, etc.).

A typical conventional PV module includes a PV laminate or panel having an assembly of crystalline or amorphous semiconductor devices (“PV cells”) electrically interconnected and encapsulated within a weather-proof barrier. One or more electrical conductors are housed inside the PV laminate through which the solar-generated current is conducted.

Regardless of an exact construction of the PV laminate, most PV applications entail placing an array of solar modules at the installation site in a location where sunlight is readily present. This is especially true for residential, commercial, or industrial applications in which multiple solar modules are desirable for generating substantial amounts of energy, with the rooftop of the structure providing a convenient surface at which the solar modules can be placed.

Solar energy systems installed on structures typically include wires and cables coupled to the various electrical components of the solar energy system. Such electrical components typically must be connected together in a junction box and coupled to the electrical circuits of the structure. If the junction box is located outside and is exposed to the elements, electrical codes typically require that the junction box be weatherproof. If, however, the wires and cables can be transitioned through the mounting surface, a lower cost junction box may be used. However, the transition through the mounting surface must not allow moisture to penetrate the mounting surface, which may cause damage to the mounting surface or structure beneath.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic perspective view of a solar power system comprising an array of solar modules mounted to a support structure;

FIG. 2 is a magnified perspective view of the solar power system illustrated in FIG. 1;

FIG. 3 is a schematic diagram of an optional electrical system connected to the array;

FIG. 4 is a perspective view of a mounting surface transition according to various embodiments;

FIG. 5 is a perspective view of the mounting surface transition of FIG. 4 with three compression fittings installed according to various embodiments;

FIG. 6A is a perspective view of the mounting surface transition of FIG. 4 installed on a mounting surface;

FIG. 6B is a sectional side view of the mounting surface transition of FIG. 4 installed on a mounting surface; and

FIG. 7 is a flowchart illustrating an example installation method for a mounting surface transition in accordance with various described embodiments.

### SUMMARY

Embodiments may include a system coupled to a mounting surface having a top side and a hole through the mounting surface, the mounting surface disposed along a north-south axis with a north end of the mounting surface disposed at a higher elevation than a south end of the mounting surface, the system comprising: a mounting surface transition coupled to the top side of the mounting surface and disposed over the hole through the mounting surface, the mounting surface transition comprising: a base portion coupled to the top side of the mounting surface, a boss portion extending upward from the base portion, wherein the boss portion comprises a first facet proximate the south end of the mounting surface, the boss portion defining a cavity over the hole, and a first compression fitting disposed in the first facet; a solar module array comprising: a first set of one or more solar modules disposed on the top side of the mounting surface, and a first cable coupled to the first set of one or more solar modules; wherein the first cable is disposed through the first compression fitting and through the hole through the mounting surface.

Embodiments may also include an apparatus comprising: a mounting surface transition adapted to couple to a mounting surface disposed along a north-south axis with a north end of the mounting surface disposed higher than a sound side of the mounting surface, the mounting surface transition comprising: a base portion coupled to a top side of the mounting surface, and a boss portion extending upward from the base portion, wherein the boss portion comprising a first facet, the boss portion defining a cavity; wherein the mounting surface transition is adapted to be coupled to the mounting surface with the first facet proximate the south end of the mounting surface.

Embodiments may further include a method comprising: providing a mounting surface transition adapted to couple to a mounting surface disposed along a north-south axis with a north end of the mounting surface disposed higher than a south end of the mounting surface, the mounting surface transition comprising: a base portion coupled to the top side of the mounting surface, a boss portion extending upward from the base portion, wherein the boss portion comprises a first facet, wherein the mounting surface transition is adapted to be coupled to the mounting surface with the first facet proximate the south end of the mounting surface; removing one or more shingles from the mounting surface; removing a portion of the mounting surface to define a hole through the mounting surface; positing the mounting surface transition on top of the mounting surface with the boss portion disposed over the hole through the mounting surface; and securing the mounting surface transition relative to the mounting surface.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” solar module does not necessarily imply that this solar module is the first solar module in a sequence; instead the term “first” is used to differentiate this solar module from another solar module (e.g., a “second” solar module).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present disclosure.

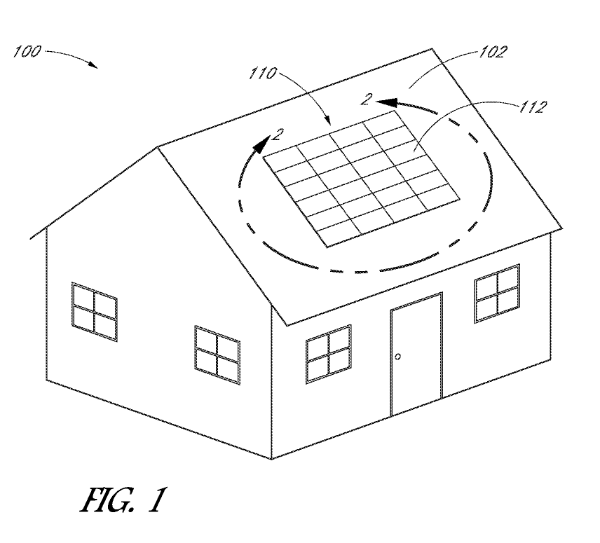

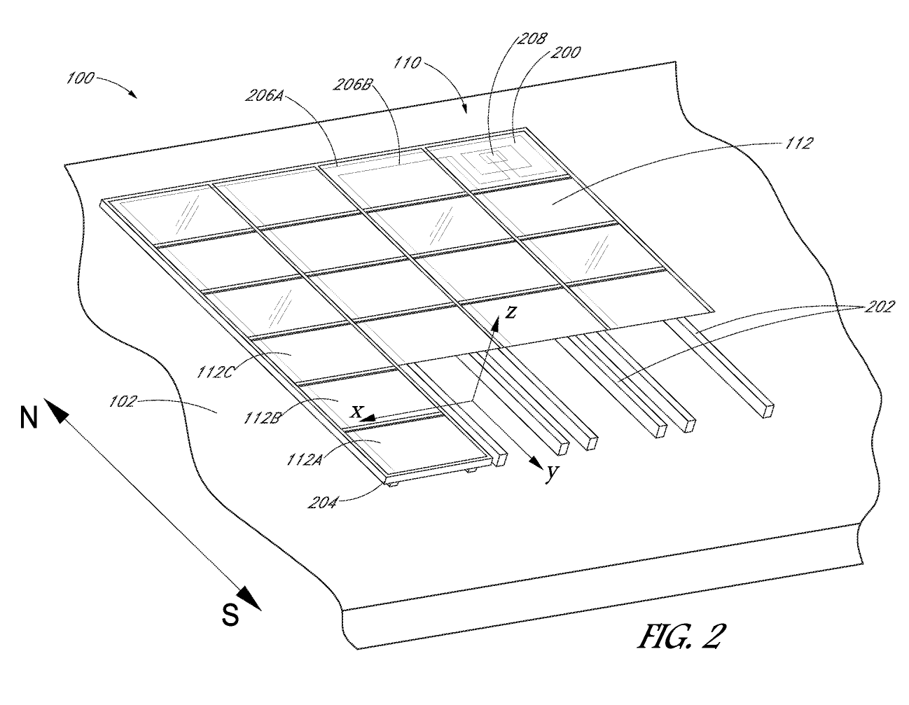

FIG. 1 is a schematic perspective view of a solar power system 100 comprising an array 110 of solar modules 112 mounted to a mounting surface 102. FIG. 2 is a magnified perspective view of the solar power system 100 illustrated in FIG. 1. The system 100 of FIGS. 1-2 is illustrated as being coupled to a mounting surface 102 that comprises a roof of a building, such as a residential, commercial, industrial structure, etc. One end of the mounting surface 102 may be disposed higher relative to the ground than another (e.g., the mounting surface 102 may be slanted or sloped). Relative to the ground beneath the structure, the mounting surface 102 may be have a slope greater than 9.4 angular degrees. There may be a superstructure under the mounting structure 102 providing support to the mounting structure 102, and which may be used to secure attachments to the mounting structure 102. For example, a plurality rafters may support a mounting surface 102 such as the roof of a building. Additionally, the mounting surface 102 may have an interlocking layer of shingles (e.g., tile shingles, composite shingles, wooden shingles) disposed on top.

The solar module 112 may include a photovoltaic (PV) laminate or panel having an assembly of crystalline or amorphous semiconductor devices (“PV cells”) electrically interconnected and encapsulated within a weather-proof barrier that includes a frame 204. In various embodiments, the solar module 112 can comprise a laminate or layered structure, with the frame 204 disposed about the laminate. The solar modules 112 may be mounted on and coupled to spaced apart rails 202 that extend across the mounting surface 102. The rails 202 and frame 204 may comprise any of a number of suitable materials including aluminum, steel, or stainless steel. Either or both of the rails 202 and frame 204 may be anodized, painted, or otherwise coated with one or more layers to protect against corrosion, wear, etc. One or more mounting surface transitions 200 may be disposed on top of the mounting surface 102 positioned over a hole 208 through the mounting surface 102. The hole 208 may be an opening formed through the mounting surface 102 (e.g., removing shingles and cutting with a hole saw). As discussed herein, the transition 200 may be used to waterproof a transition of round elongated components (e.g., wires, cables, conduits, tubes, pipes, etc.) from the top of a mounting surface 102 to beneath the mounting surface 102 (e.g., from the exterior of a roof into the attic). By transitioning the round elongated components (e.g., wires, cables, conduits, tubes, pipes, etc.) to the interior of the structure, the round elongated components may be coupled together or to other components (e.g., wires coupled together by a junction box and connected to the electrical circuits of the structure) using components that do not need to be weatherproofed and are therefore likely to be less expensive than weather proofed components.

The transition 200 may receive one or more electrical branch circuit wirings 206 for a water-resistant transition of the electrical branch circuit wiring 206 through the mounting surface 102 (e.g., from on top of a roof of a building, through the roof via the hole 208, and into the interior of the building). It will be understood that each transition 200 may be used to help waterproof a mounting structure 102 and prevent moisture (e.g., precipitation, ocean spray, etc.) from penetrating the mounting structure 102 through the hole 208. As discussed herein, the transition 200 may be made of one or more of metal, polymer, or composite. The transition 200 may be manufactured as a single piece (e.g., stamped a piece of metal; injection molded polymer; three-dimensional printed metal, polymer, or composite, etc.) or multiple pieces joined together (e.g., two pieces of metal welded together, two pieces of polymer joined by adhesive or epoxy).

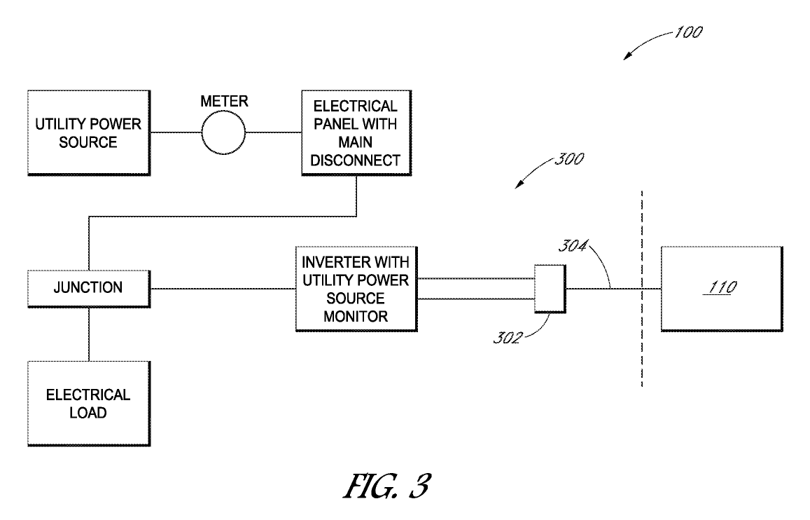

The array 110 may also include electrical branch circuit wiring 206 (e.g., branch circuit wiring 206A for a first branch circuit and branch circuit wiring 206B for a second branch circuit). The branch circuit wiring 206 may electrically couple each solar module 112 connected to a particular branch circuit and couple the branch circuit to an electrical panel (e.g., central electrical panel, aggregation panel, main electrical panel) and in turn to an electrical meter and electrical load as discussed in connection to FIG. 3. Beneficially, the electrical panel may be located within the building (e.g., within an attic of a residential building), so as to obviate the use of expensive waterproofing techniques for components that may otherwise be exposed to moisture outside the building. The branch circuit wiring 206 may comprise a series of cables connecting one solar module 112 to other solar modules 112. For example, a first solar module 112A, second solar module 112B, and third module 112C may be disposed next to each other as shown in FIG. 2. Each solar module 112 may have a positive terminal and a negative terminal. The positive terminal of solar module 112A may be coupled to the negative terminal of solar module 112B and the positive terminal of solar module 112B may be coupled to the negative terminal of solar module 112C. In this way, the branch circuit wiring 206 for each branch circuit may include a chain of solar modules 112 in series. For example, each branch circuit may include as many as twelve solar modules 112 (although more or fewer may be present dependent upon the configuration of the array 110). Alternatively, the branch circuit wiring 206 may comprise a single wire or cable coupled to each solar module 112 coupled to the branch circuit. Additionally, some or all of the branch circuit wiring 206 may be disposed in a metal or polymer electrical conduit.

While the example disclosed in connection to FIGS. 1-2 shows a transition 200 being used to transition electrical branch circuit wiring 206 from the top of the mounting surface 102 to the interior beneath the mounting surface 102, it will be understood that the transition 200 may be used to transition any elongated components (e.g., rounded components) from the top of the mounting surface 102 to the interior beneath the mounting surface 102. For example, the transition 200 may be used to transition wires, cables (e.g., branch circuit wiring 206), conduits (e.g., branch circuit wiring 206 disposed inside an electrical conduit), pipes (e.g., coupled to a swamp cooler, an air conditioner, or water heater), tubes, etc. from the top of the mounting surface 102 to the interior beneath the mounting surface 102.

As shown in FIG. 2, a global x-y-z coordinate system can be defined across the mounting surface 102. For example, the rails 202 can extend along a length in the y-direction, and the array 110 can be positioned atop the rails 202 in the x-y plane. As used herein, the x-y-z coordinate system shown in FIG. 2 defines a global frame of reference for the solar modules 112 and other components disclosed herein. As discussed herein, the mounting surface 102 may be slanted with one end higher than another. Because most arrays 110 are installed on a south-facing mounting surface 102 to maximize sun exposure, for the sake of reference the highest end of the mounting surface 102 may be referred to as the north end and the lowest end of the mounting surface 102 may be referred to as the south end of the mounting surface 102. It will be understood, however, that “north end” and “south end” are only approximations and the mounting surface 102 may not be disposed precisely on a north-south axis.

FIG. 3 is a schematic diagram of an optional electrical system 300 connected to the array. The solar power system 100 can be incorporated into the electrical system 300 connected to the array 110. For example, the electrical system 300 can include the array 110 as a power source connected to a remote connection device 302 with power lines 304. The electrical system 300 can also include a utility power source, a meter, an electrical panel with a main disconnect, a junction, electrical loads, and/or an inverter with the utility power source monitor. Additionally or alternatively, each module 112 may be coupled to its own dedicated microinverter converting the DC power generated by the module 112 into AC power.

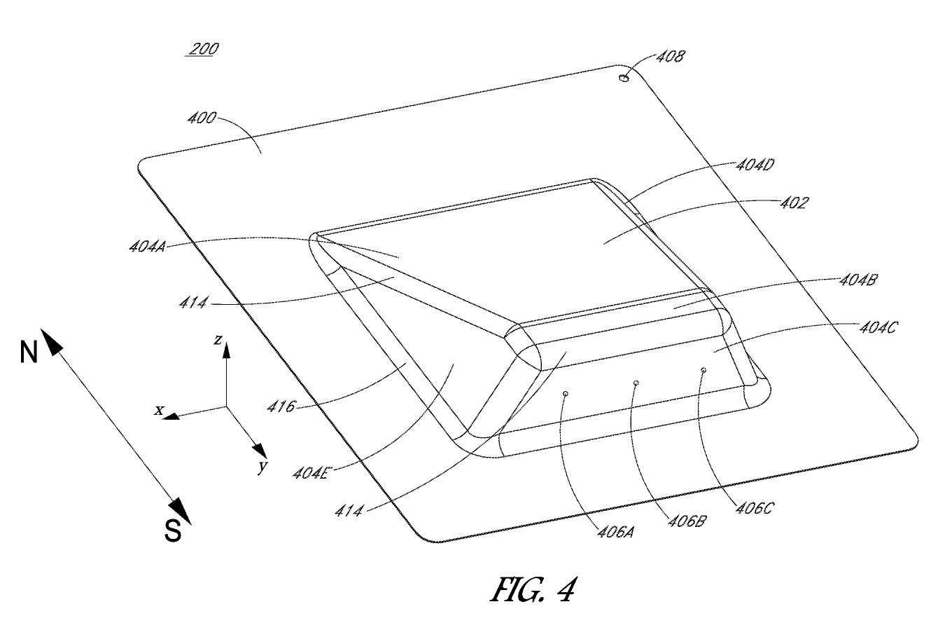

FIG. 4 shows a perspective view of a transition 200. The transition includes a base portion 400, a boss portion 402, one or more facets 404, one or more dimples 406, and one or more apertures 408. As discussed herein, when installed on a mounting surface 102, the transition 200 may be disposed on roughly a north-south axis with a north end N of the transition 200 being disposed higher than a south end S. Accordingly, one end of the transition 200 may be referred to as the north end N and the opposing end may be referred to as the south end S herein. As discussed herein, the transition 200 may have a low profile and allow for round elongated components (e.g., wires, cables, conduits, pipes, tubes, etc.) to be transitioned from the top of the mounting surface 102, through the mounting surface 102, and into the interior of the structure beneath. The low profile may give users more flexibility in where to install the transition 200, including underneath a solar module 112 as shown in FIG. 2.

The base portion 400 may be substantially rectangular or square-shaped with rounded corners as shown in FIG. 4. Alternatively, the corners of the base portion 400 may be pointed. The base portion 400 may be about 12 inches long and 12 inches wide. The base portion 400 may be substantially flat. The base portion 400 may include a plurality of apertures 408 disposed around its perimeter (e.g., one at each of the two corners on the north-most end, one in the middle of some or all of the four sides). Each aperture 408 may be configured to accept a fastener (e.g., roofing nail, screw, etc.) to secure the base portion 400 relative to the mounting surface.

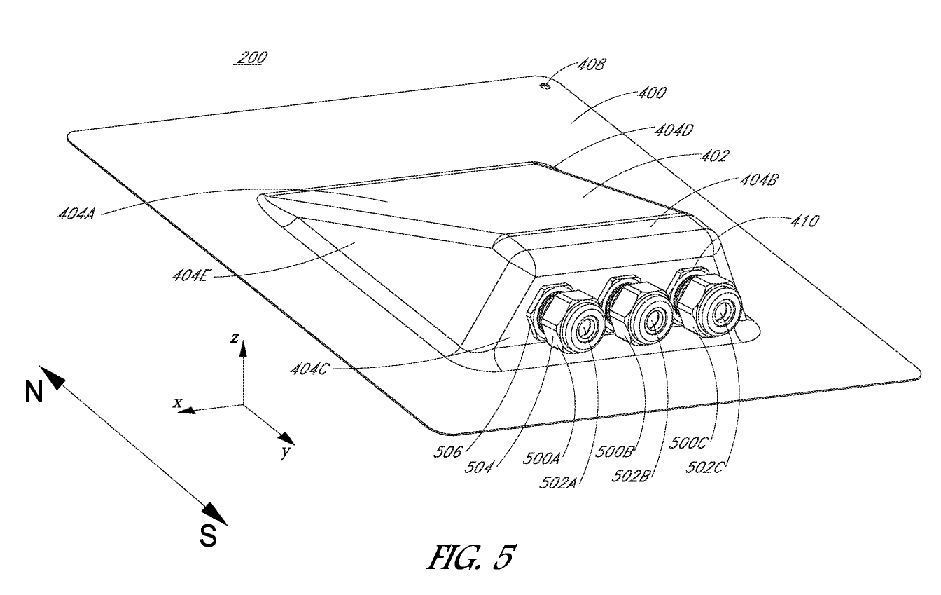

The boss portion 402 may extend upwardly (i.e., in the z-axis) from the base portion 400. The boss portion 402 may comprise a contoured sheet with one or more facets 404. As shown in FIG. 4, the boss portion 402 may comprise a first facet 404A that rises from the base portion 400 at an acute angle relative to the base portion 400 on the north-most facet (e.g. an upwardly angled facet extending along a generally north-south direction), a second facet 404B that levels off for a short distance at the highest point, and a third facet 404C that angles back downwardly towards the base portion at an steeper angle relative to the base portion 400 at the south-most facet (e.g., at an angle between 80 to 100 angular degrees). As illustrated, the first facet 404A can comprise a ramped surface, which may beneficially cause fluids (e.g., rainfall, snowfall, ocean spray) to flow or slide downward along the boss portion 402 without entering the internal cavity of the boss portion 402. When installed, the south-most facet 404C is proximate to the south end of the mounting surface 102. The boss portion 402 may also include one or more facets 404D on the east side and one or more facets 404E on the west side of the boss portion 402. As shown in FIG. 4, corners 412 between facets 404 may be rounded. Additionally, a boundary 414 between the base portion 400 and boss portion 402 may be rounded. Alternatively, either or both of the corners or boundary may be sharp instead of rounded. The south-most facet 404 may include one or more dimples 406 (e.g., three dimples 406A, 406B, and 406C as shown in FIG. 4). Each dimple 406 may be a feature marking a location at which the south-most facet 404 is adapted to have a portion removed to define an aperture 410 adapted to receive a compression fitting 500 (both shown on FIG. 5) as discussed herein.

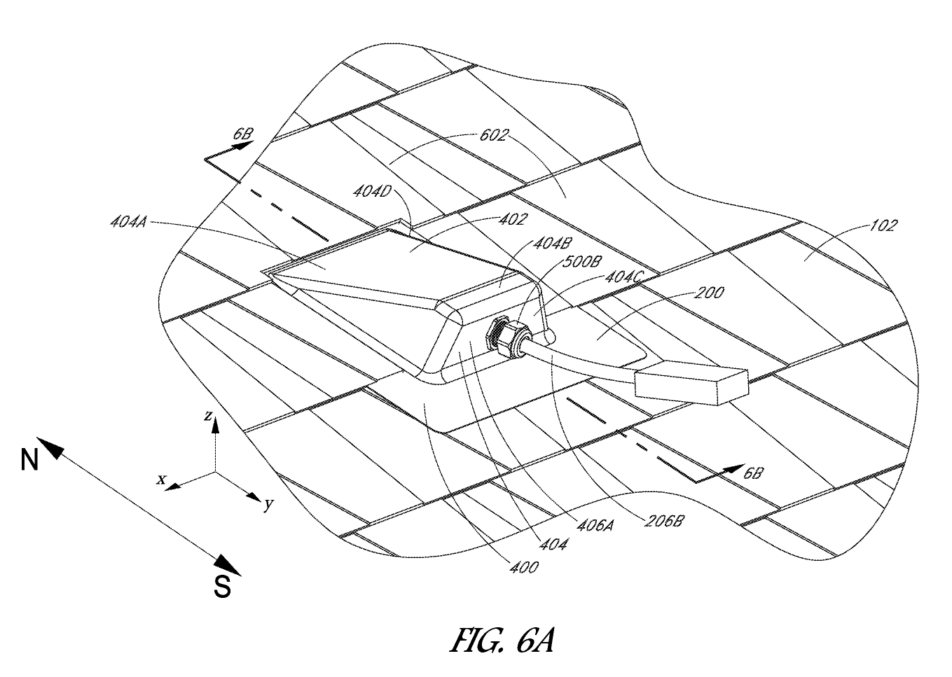

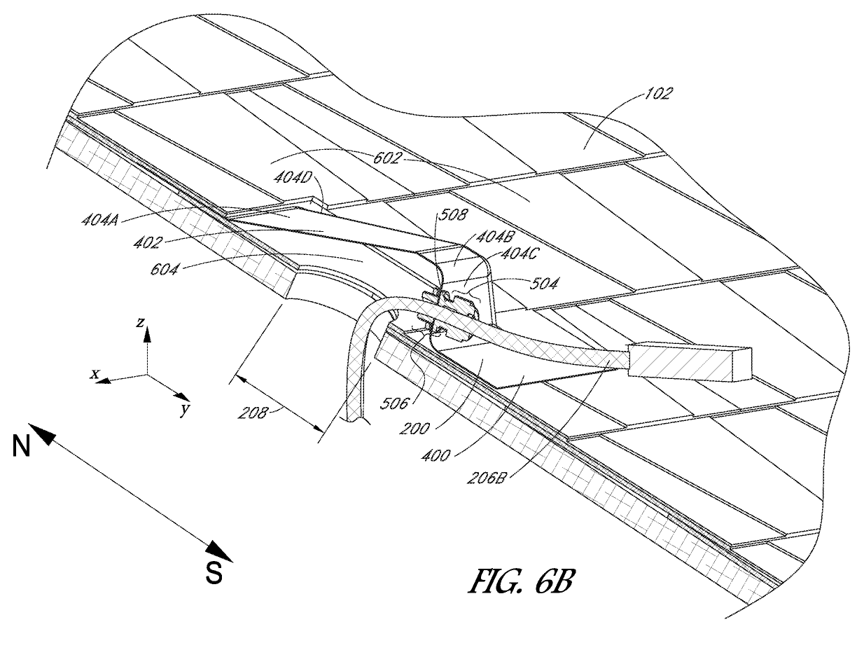

The south-most facet 404C shown in FIG. 4 includes three dimples 406, but it will be understood that fewer or more dimples may be included. Additionally, the boss portion 402 shown in FIG. 4 measures 6 inches long and 6 inches wide and extends 2 inches from the base portion 400 at the highest point. Of course, will be understood that the boss portion 402 may be longer, wider, or extend higher from the base portion 400. By its length, width, and height, the boss portion 404 defines a cavity (e.g., the cavity 604 shown in FIG. 6B herein). When the transition 200 is installed on the mounting surface 102, the boss portion 402 is optimally disposed above the hole 208, and the cavity provides clearance to transition the branch circuit wiring 206 through the mounting surface 102.

FIG. 5 is a perspective view of a transition 200 with three compression fittings 500A, 500B, and 500C installed in three apertures 410. For the transition 200 shown in FIG. 5, a user (e.g., technician, installer, home owner) has formed three apertures 410 through the south-most facet 404C and installed a compression fitting 500 inside each aperture 410. Each compression fitting 500 includes an opening 502 disposed though a gland nut 504, through a body 506, and into the cavity defined by the boss portion 402. The opening 502 may be adapted to couple to a cap (not shown) to cover the opening 502 when not in use (e.g., when more compression fittings 500 are installed than are needed currently but may be needed in the future). As shown in FIG. 5, the compressing fitting 500 can be angled towards the south end of the structure, and/or may be disposed generally parallel with the mounting structure 102. Angling the compressing fitting 500 in such a manner can reduce pooling of liquid at or near the opening and can enable the cables (or other elongate conduits) to be easily engaged with the fitting 500.

The body 506 includes a threaded portion adapted to receive the gland nut 504 on the exterior side of the boss portion 402 and a shoulder disposed on the exterior of the boss portion 402 just outside the aperture 410. As the gland nut 504 is tightened onto the body 506, the gland nut 504 narrows the opening 502 around an elongated component (e.g., a rounded elongated component, such as branch circuit wiring 206) disposed through the opening 500, creating a moisture-resistant seal around the round elongated component. The body 506 may fit snugly inside the aperture 410 with a gasket around the outer circumference of the body 506 to prevent moisture intrusion into the boss portion 402. Adhesive or caulk may be applied around the outer circumference of the body 506 for added security and moisture-proofing. Further, the body 506 may include a locknut (not shown) disposed on the interior side of the boss portion 402 to secure the compression fitting 500 relative to the transition. Alternatively, while compression fittings 500 are shown in FIG. 5, other similar devices that may create a moisture resistant seal around elongated components may be used. The compression fittings 500 and boss portion 402 can cooperate to create a fluid seal, a waterproof seal, a splashproof seal, a weatherproof seal, etc.

FIG. 6A is a perspective view of a transition 200 installed on a mounting surface 102 with shingles. The transition 200 shown in FIG. 6A has one compression fitting 500 installed in the middle of the south-most facet 404C, and branch circuit wiring 206 (e.g., the branch circuit wiring 206B shown in FIG. 6A) has been installed through the compression fitting 500, through the transition 200, through the hole 208 in the mounting surface 102, and into the interior of the structure. FIG. 6A shows a plurality of shingles 602 disposed on top of the mounting surface 102. In order to accommodate the transition 200, some of the shingles 602 have been trimmed (e.g., a narrow portion of the south-most edge of shingle 602 directly north of the boss portion 402 has been trimmed to accommodate the boss portion 402 extending from the mounting surface).

FIG. 6B is a sectional side view of a transition 200 installed on a mounting surface 102 with shingles. The transition 200 shown in FIG. 6B has one compression fitting 500 installed in the middle of the south-most facet 404C. The compression fitting 500 includes a gland nut 504 and a body 506 disposed in the aperture 410 in the south-most facet 404C. Brach circuit wiring 206 (e.g., the branch circuit wiring 206B shown in FIG. 6B has been installed through the compression fitting 500, through the transition 200, through the hole 208 in the mounting surface 102, and into the interior of the structure. The compression fitting 500 creates a weatherproof seal around the branch circuit wiring 206. Additionally, the internal structure of the cavity 604 can be seen in FIG. 6B. The cavity 604 provides adequate clearance for the branch circuit wiring 206 (or other elongated components as discussed herein) to bend down (in the z-axis) into the hole 208 and into the interior of the structure.

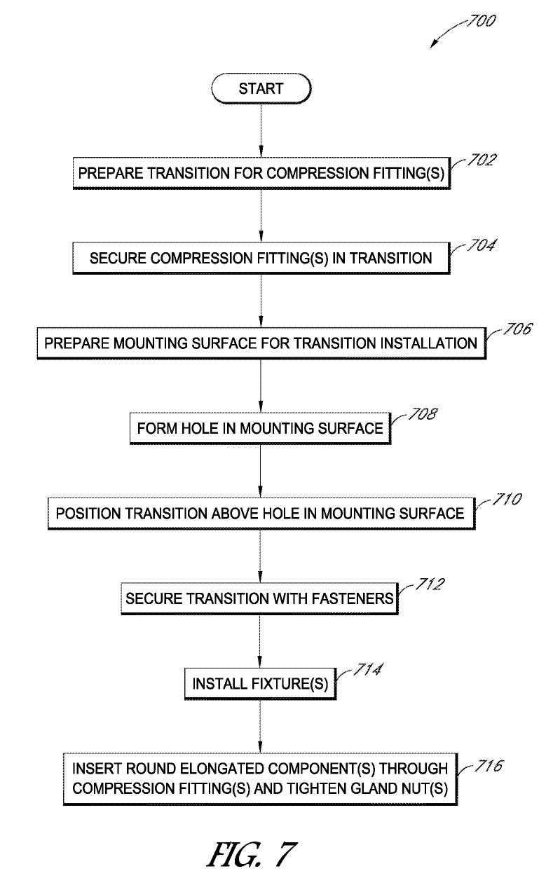

Referring now to FIG. 7, a flowchart illustrates a mounting surface transition installation method 700. The method 700 may be performed by one or more users (e.g., technicians, installers, homeowners, etc.) installing a mounting surface transition 200 on top of a mounting surface 102 as part of installing a fixture (e.g., array 110, water heater, air conditioner) on top of the mounting surface 102. The various tasks represented by the various method steps may be performed in different orders than shown in FIG. 7, tasks may be omitted, and tasks may be performed over a short period of time (e.g., over a few days or weeks) or performed over a long period of time (e.g., installing the transition 200 when a structure is built or reroofed, and installing the fixture years later).

At method step 702, the user may prepare the transition 200 for installation by forming one or more apertures 410 through the south-most facet 404 at one or more of the dimples 406. If the user knows how many round elongated components will be transitioned from the exterior of the mounting surface 102 into the interior of the structure, the user may form as many apertures 410 as needed (e.g., two apertures 410 if installing an array with two branch circuits each with its own branch circuit wiring 206). Alternatively, the user may form as many apertures 410 as can be accommodated by the south-most facet (e.g., three apertures 410) and put caps over any compression fittings 500 that are not to be put to immediate use. At method step 704, the user may install a compression fitting 500 into each aperture 410. The compression fittings 500 may be configured to be inserted into an aperture 410 of a particular diameter and secured relative to the aperture 410 with a gasket, adhesive, and/or locknut.

At method step 706, the user may prepare the mounting surface 102 by removing and trimming shingles 600 as needed to accommodate the transition 200. At method step 708, the user may form a hole 208 in the mounting surface 102 (e.g., by using a hole saw, large drill, etc.). At method step 710, the user may position the transition 200 over the hole 208. At method step 712, the user may secure the transition 200 relative to the mounting surface 102 using, for example, fasteners through the plurality of apertures 408. At method step 714, one or more users may install a fixture including round elongated components to be transitioned from the exterior of the mounting surface 102 to the interior of the mounting surface 102 (e.g., a solar array 110 with branch circuit wiring 206 as exposed cables or in conduits). At method step 716, the user may remove a cap covering the opening 502 of the compression fitting (if present), insert the round elongated components through the one or more compression fittings 500, and tighten the compression fittings to prevent moisture from penetrating the mounting surface.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A system coupled to a mounting surface having a top side and a hole through the mounting surface, the mounting surface disposed along a north-south axis with a north end of the mounting surface disposed at a higher elevation than a south end of the mounting surface, the system coupled to the mounting surface comprising:
a mounting surface transition coupled to the top side of the mounting surface and disposed over the hole through the mounting surface, the mounting surface transition comprising:
a base portion coupled to the top side of the mounting surface, the base portion including a flat sheet;
a boss portion extending upward from the base portion, wherein the boss portion comprises a first facet proximate the south end of the mounting surface, the boss portion comprises a second facet proximate the north end of the mounting surface, the boss portion comprises a third facet extending along the north-south axis and positioned between the first facet and the second facet, and the boss portion defining a cavity over the hole, and
a first compression fitting disposed in the first facet; a solar module array comprising:
a first set of one or more solar modules disposed on the top side of the mounting surface, and
a first cable coupled to the first set of one or more solar modules;
wherein the first cable is disposed through the first compression fitting and through the hole through the mounting surface,
wherein the second facet rises from the flat sheet of the base portion at an acute angle relative to the base portion,
wherein the second facet extends a first distance along a length of the boss portion between the north end to the south end, the first facet extends a second distance along the boss portion between the north end and the south end, wherein the first distance is greater than the second distance.

2. The system of claim I wherein the first facet comprises one or more features marking a location at which the first facet is adapted to have a portion removed to define an aperture adapted to receive a second compression fitting.

3. The system of claim 1 wherein the mounting surface transition further comprises a second compression fitting disposed in the first facet.

4. The system of claim 3, wherein the solar module array further comprises:
a second set of one or more solar modules disposed on the top side of the mounting surface, and
a second cable coupled to the second set of one or more solar modules
wherein the second cable is disposed through the second compression fitting and through the hole through the mounting surface.

5. The system of claim 3, wherein the mounting surface transition further comprises a cap coupled to the second compression fitting.

6. The system of claim 1,
wherein the first facet and the flat sheet intersect at an angle between 80 and 100 angular degrees.

7. The system of claim 1 wherein the boss portion comprises a contoured sheet, and the base portion of the mounting surface transition and the boss portion of the mounting surface transition comprise a single piece of stamped metal.

8. The system of claim 1 wherein the mounting surface transition is adapted to prevent fluid on the mounting surface from penetrating the mounting surface and the compression fitting defines a weatherproof seal aroimd a periphery of the first cable.

9. An apparatus comprising:
a mounting surface transition adapted to couple to a mounting surface disposed along a north-south axis with a north end of the mounting surface disposed higher than a sound side of the mounting surface, the mounting surface transition comprising:
a base portion coupled to a top side of the mounting surface, the base portion including a flat sheet; and
a boss portion extending upward from the base portion, the boss portion comprising a first facet, the boss portion comprising a second facet proximate the north end of the mounting surface. the boss portion comprising a third facet extending along the north-south axis and positioned between the first facet and the second facet, and the boss portion defining a cavity;
wherein the mounting surface transition is adapted to be coupled to the mounting surface with the first facet proximate the south end of the mounting surface,
wherein the second facet rises from the flat sheet of the base portion at an acute angle relative to the base portion,
wherein the second facet extends a first distance along a length of the boss portion between the north end to the south end, the first facet extends a second distance along the boss portion between the north end and the south end, wherein the first distance is greater than the second distance.

10. The apparatus of claim 9 wherein the first facet comprises:
one or more features marking a location at which the first facet is adapted to have a portion removed to define an aperture adapted to receive a first compression fitting.

11. The apparatus of claim 9 wherein the mounting surface transition further comprises a first compression fitting disposed in the first facet.

12. The apparatus of claim 11 wherein the mounting surface transition further comprises a cap coupled to the first compression fitting.

13. The apparatus of claim 11 wherein the first compression fitting is adapted to receive one or more of a wire, cable, conduit, tube, or pipe.

14. The apparatus of claim 11 wherein the mounting surface transition further comprises a second compression fitting disposed in the first facet.

15. (canceled)

16. The apparatus of claim 9 wherein the boss portion comprises a contoured sheet, and the base portion of the mounting surface transition and the boss portion of the mounting surface transition comprise a single piece of stamped metal.

17. A method comprising:
providing a mounting surface transition adapted to couple to a mounting surface disposed along a north-south axis with a north end of the mounting surface disposed higher than a south end of the mounting surface, the mounting surface transition comprising:
a base portion coupled to the top side of the mounting surface, the base portion including a flat sheet,
a boss portion extending upward from the base portion, the boss portion comprising a first facet, the boss portion comprising a second facet proximate the north end of the mounting surface and rising from the flat sheet of the base portion at an acute angle relative to the base portion, wherein the second facet extends a first distance along a length of the boss portion between the north end to the south end, the first facet extends a second distance along the boss portion between the north end and the south end, wherein the first distance is greater than the second distance, the boss portion including a third facet extending along the north-south axis and positioned between the first facet and the second facet, and
wherein the mounting surface transition is adapted to be coupled to the mounting surface with the first facet proximate the south end of the mounting surface;
removing one or more shingles from the mounting surface;
removing a portion of the mounting surface to define a hole through the mounting surface;
positing the mounting surface transition on top of the mounting surface with the boss portion disposed over the hole through the mounting surface; and
securing the mounting surface transition relative to the mounting surface.

18. The method of claim 17 further comprising:
removing a portion of the first facet to define an aperture; and
inserting a first compression fitting into the aperture.

19. The method of claim 18 further comprising:
providing a solar module array comprising:
a first set of one or more solar modules disposed on top of the mounting surface, and
a first cable coupled to the first set of one or more solar modules; and
disposing the first cable through the first compression fitting.

20. The method of claim 17 wherein the mounting surface transition comprises a first compression fitting disposed in the first facet and a cap coupled to the first compression fitting, the method further comprising:
removing the cap coupled to the first compression fitting.
